(19) United States
(12) Patent Application Publication
(10) Pub. No.: US 2014/0164405 A1
(43) Pub. Date: Jun. 12, 2014

(54) DYNAMIC DATA MASKING METHOD AND DATABASE SYSTEM

(71) Applicant: INSTITUTE FOR INFORMATION INDUSTRY, Taipei (TW)

(72) Inventors: Lin-Jiun TSAI, Taipei City (TW); Song-Kong CHONG, Pingtung County (MY); Jain-Shing WU, Taipei City (TW)

(73) Assignee: INSTITUTE FOR INFORMATION INDUSTRY, Taipei (TW)

(21) Appl. No.: 13/757,843

(22) Filed: Feb. 3, 2013

(30) Foreign Application Priority Data
Dec. 12, 2012 (TW) 101146927

(51) Int. Cl. G06F 21/62

(52) U.S. Cl. CPC G06F 21/6227
USPC 707/754

(57) ABSTRACT

A dynamic data masking method, suitable for a database including plural data, is disclosed in this invention. Each of the data includes plural values and plural keys corresponding to the values. The dynamic data masking method includes steps of: determining whether values and keys of one data are sensitive contents when the data are requested to be written into the database; if one of the values/keys of the data is sensitive, setting a key corresponding to the sensitive value or the key itself as a sensitive key and dynamically establishing a filtering rule corresponding to the key; and then, saving the filtering rule and writing the data into the database. In addition, a database system is also disclosed herein.

### RELATED APPLICATIONS

This application claims priority to Taiwan Patent Application Serial Number 101146927, filed Dec. 12, 2012, which is herein incorporated by reference.

### BACKGROUND

1. Technical Field

The present disclosure relates to a data processing method. More particularly, the present disclosure relates to a data processing method for protecting sensitive contents and a database system.

2. Description of Related Art

Cloud-computing networks are widespread in recent years. More and more important information (such as personal identity information, billing, letter, the company's business files, government documents, etc.) is stored in various types of cloud-networking databases. Users can easily access a variety of information stored in the database through the Internet.

The traditional architecture of the databases, such as the Relational Database Management System (RDBMS) and the relational database based on the Structured Query Language (SQL), is no longer capable to cope with the mass data access demanding in the cloud-networking era. Therefore, the non-relational database (e.g., NoSQL) architecture is developed in recent years. There are some practical examples of non-relational databases, such as Google BigTable, Facebook Cassandra, Yahoo Hbase and Amazon DynamoDB.

The traditional relational database has predetermined columns (or keys) and values related to the columns. In response to different requirements or different user data, the traditional relational database must be re-designed to implement appropriate columns as well as appropriate correspondences between the columns and the values.

The non-relational database is relatively dynamic and flexible. Each data in the non-relational database may have multiple values and the corresponding multiple columns. Therefore, the non-relational database architecture (e.g., NoSQL) is an appropriate database for dealing with the large amount of could-networking data accesses, better than the traditional relational database management system.

Recently, the could-networking databases need to perform some a certain masking treatment while handling some important and sensitive information (such as personal identity card number, telephone number, mailing address, etc.), such as masking the phone number “0921345678” into “09xxxxx678”, so as to protect some sensitive information of users.

There are some common data masking technologies including the static data masking and the dynamic data masking.

The static data masking technology can be applied on sensitive data in the relational database, and store the masked data contents into a de-identified database accessible for all users. However, the de-identified database generated by the static data masking technology no longer remains the original data contents. The masked data contents can not be updated dynamically. The de-identified database can not provide different masked outcomes for different levels of user identifications (e.g., public users or a system administrator). Therefore, the application of the de-identified database is limited.

Dynamic data masking technology may de-identify the sensitive data in real-time according to different user identifications. Currently, the common dynamic data masking technology is achieved by intercepting the instructions of Structured Query Language (SQL) and amending the response packet (masking information in the response packet), so as to protect the sensitive information.

Current dynamic data masking technology may define which column in the target database is sensitive in advance (the sensitivity configuration must be set up in advance by a system supervisor). However, the columns within the non-relational database may change dynamically based on newly-added information. Along with the information in the non-relational database increasing over time, the amount of columns will increase correspondingly. Due to the characteristics of the non-relational database, the managers can not effectively define the relevant attribute of columns and the filtering rules thereof. Therefore, the traditional method, which includes steps of predetermining the sensitive columns and intercepting the instructions of Structured Query Language for protecting the sensitive information, can not be applied on new non-relational databases.

In addition, traditional dynamic data masking technology only intercepts the inquiring instructions when the user requests to read data in the database and modifies the response packet, but the traditional dynamic data masking does not involve steps of analyzing or judging the data while the data writing into the database. There is no correlation established between the data-writing procedure and the data-reading procedure automatically. Therefore, the system supervisors must define the relevant attribute of columns and the filtering rules according to their own judgment, which may cause the leakage of sensitive information.

### SUMMARY

To solve the problems in the art, the invention provides a dynamic data masking method and a database system. During the data-writing stage, the method is performed to scan values (and keys corresponding to the values) to be written into the database and dynamically establish the filtering rules according to the values (and the keys). During the data-reading stage, the method is performed to mask the response contents in real time with the filtering rules dynamically established before. The filtering rules in this invention are generated by automatic judgment during the data-writing stage according to whether the values (and the keys) are sensitive or not. The system supervisors are not required to define the sensitive keys or filtering rules by custom. Therefore, the dynamic data masking method is suitable for both of the new-typed non-relational database and traditional the relational database. In addition, an embodiment of the invention may further provide different inquiring result of sensitive data according to different levels of user identifications.

An aspect of the disclosure is to provide a dynamic data masking method, which is suitable for a database for storing plural data. Each data includes plural values and plural keys corresponding to the values. The dynamic data masking method includes steps of: determining whether values and keys of one data are sensitive or not when the data requests to be written into the database; if one of the values or one of the keys in the data to be written is sensitive, setting a key corresponding to the sensitive value or the key itself as a sensitive key and dynamically establishing a filtering rule corresponding to the sensitive key; and, storing the filtering rule and writing the data into the database.

Another aspect of the disclosure is to provide a database system, which includes a database and a data processing unit. The database is configured for storing a plurality of data. Each data includes plural values and plural keys corresponding to the values. The data processing unit is communicatively connected with the database and configured for processing a request to write in or read from the database. When one data requests to be written into the database, the data processing unit determining whether values and keys of the data to be written are sensitive or not. If one of the values or one of the keys in the data to be written is sensitive, the data processing unit sets a key corresponding to the sensitive value or the key itself as a sensitive key and dynamically establishing a filtering rule corresponding to the sensitive key.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference to the accompanying drawings as follows:

FIG. 1 is a schematic diagram illustrating a database system according to an embodiment of the invention;

FIG. 2 is a flowchart illustrating the data masking method during the data-writing stage according to an embodiment of the invention;

FIG. 3 is a flowchart illustrating the data masking method during the data-reading stage according to an embodiment of the invention;

FIG. 4 is a flowchart illustrating the data masking method during the data-writing stage according to another embodiment of the invention; and

FIG. 5 is a flowchart illustrating the data masking method during the data-reading stage according to another embodiment of the invention.

### DESCRIPTION OF THE EMBODIMENTS

In the following description, several specific details are presented to provide a thorough understanding of the embodiments of the present disclosure. One skilled in the relevant art will recognize, however, that the present disclosure can be practiced without one or more of the specific details, or in combination with or with other components, etc. In other instances, well-known implementations or operations are not shown or described in detail to avoid obscuring aspects of various embodiments of the present disclosure.

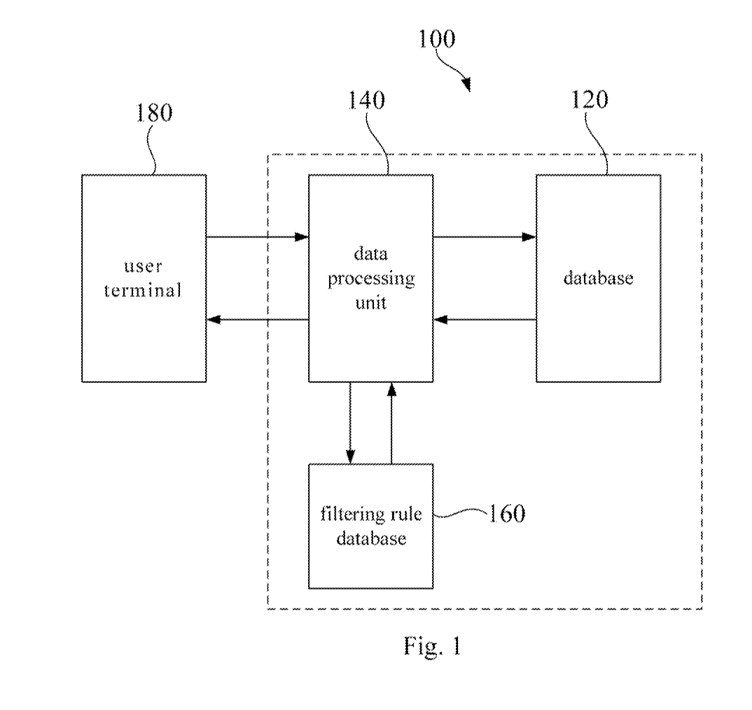

Reference is made to FIG. 1, which is a schematic diagram illustrating a database system 100 according to an embodiment of the invention. As shown in FIG. 1, the database system 100 includes a database 120 and a data processing unit 140. The database can be utilized to store plural data. Each data include plural values and plural keys corresponding to the values. The data processing unit 140 is communicatively connected with the database 120. The data processing unit 140 is configured to handle request of writing into or reading from the database 120. In the embodiment, the database system 100 may further include a filtering rule database 160 communicatively connected with the data processing unit 140, but the invention is not limited thereto.

In this embodiment, the data processing unit 140 can be a network gateway. A user terminal 180 can write into the database 120 or read from the database 120 via the network gateway (the data processing unit 140). To be added that, the user terminal 180 is not limited to a specific user. It can be any data source. For example, the owner of the database system 100 may also be the “user” as well. Therefore, the “user terminal” is not limited to the data source of the database system 100. For example, the “user terminal” may also be a requester of reading information from the database system 100, or a manager who tends to modify or control the database system 100.

In the embodiment, the data processing unit 140 is not limited to a network gateway. The data processing unit 140 may also be a controlling circuit integrated on a network gateway or a controlling circuit integrated on the database 120. In addition, the database 120 in the disclosure can be a non-relational database (e.g., NoSQL) or a relational database.

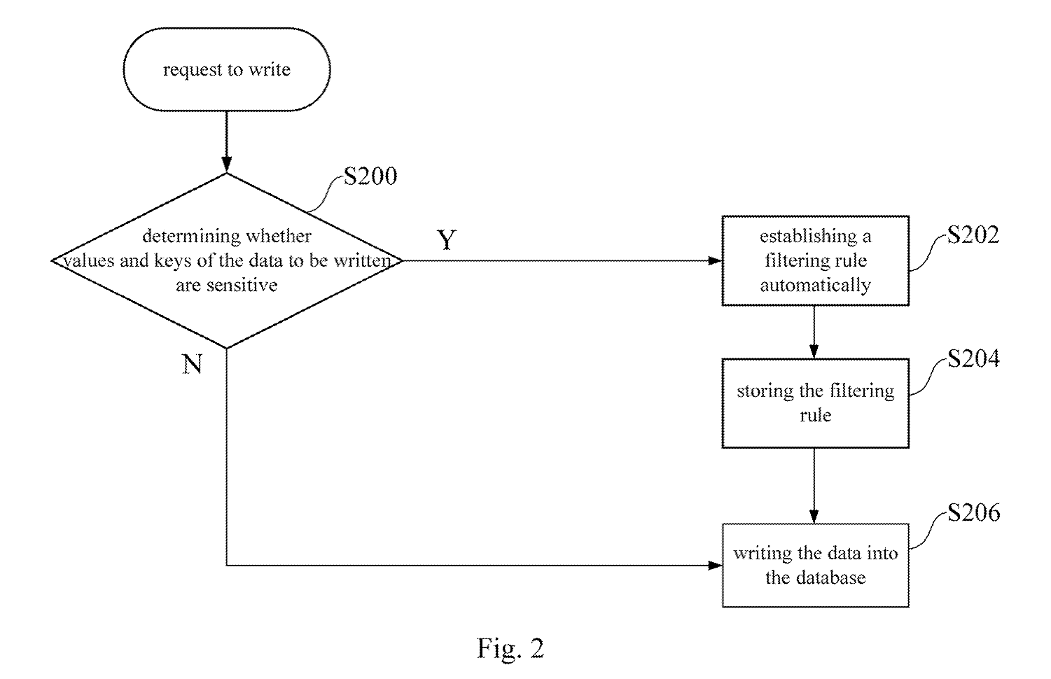

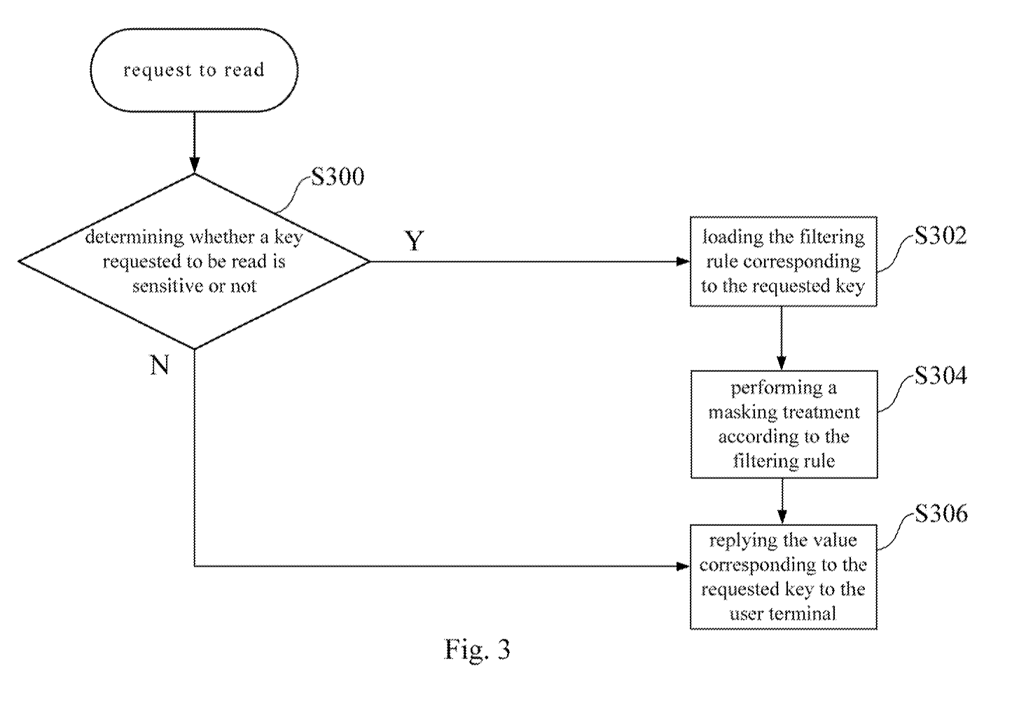

In this embodiment, the database system 100 may execute a dynamic data masking method during the data-writing procedure and the data-reading procedure, so as to protect the security of sensitive contents. Practices of the dynamic data masking method can be referred to FIG. 2 and FIG. 3 for further details. FIG. 2 is a flowchart illustrating the data masking method during the data-writing stage according to an embodiment of the invention. FIG. 3 is a flowchart illustrating the data masking method during the data-reading stage according to an embodiment of the invention.

As shown in FIG. 1 and FIG. 2, it is assumed that the user terminal 180 requests to write one data into the database 120. At the time, the data processing unit 140 executes step S200 for determining whether values and keys of the data to be written are sensitive. In some embodiments, the data processing unit 140 can determine whether the values and the keys are sensitive or not according to an algorithm. In practices, the algorithm can be selected from at least one algorithm consisting of Regular Expression (regex) algorithm, Machine Learning algorithm and Signature algorithm.

On the other hand, in some other embodiments, the data processing unit 140 can determine whether the values and the keys are sensitive or not by referring to a lookup table. In these embodiments, the data processing unit 140 may maintain the lookup table with some common sensitive contents, such as family names, a format of addresses or some certain keywords.

If one of the values or one of the keys in the data to be written is determined to be sensitive in step S200, the data processing unit 140 executes step S202 for establishing a filtering rule automatically. If it is one value in the data being determined to be sensitive, step S202 sets a key corresponding to the sensitive value as a sensitive key, and dynamically establishes a filtering rule corresponding to the sensitive key; on the other hand, if it is the key itself being determined to be sensitive, step S202 sets the key itself as a sensitive key and dynamically establishing a filtering rule corresponding to the sensitive key.

It is assumed that the data to be written is shown in Table 1, as follow:

TABLE 1

| | |
|---|---|
| KEY | VALUE |

| | | |
|---|---|---|
| user001 | email | abc123@gmail.com |
| user001 | passport_num | 3456789012 |
| user001 | text | Hello, everyone! |

As the example shown in Table 1, one value of the data to be written is “abc123@gmail.com”. Step S200 determines the value is sensitive. Step S202 may set the corresponding key “user001.email” as a sensitive key, and dynamically establishing a filtering rule corresponding to this sensitive key “user001.email”. For example, the filtering rule can be replacing the first character to the third character from the string of the value into another character (e.g., the character “*”). According to an example, the filtering rule can be represented in a programming language as below:
MaskRule(substr(user001.email, 1,3)∥‘***’)

Besides, as the example shown in Table 1, one key itself of the data to be written is about password numbers, i.e., “passport_num”. Step S200 determines the key itself is sensitive. Step S202 may set the corresponding key “user001.passport_num” as a sensitive key, and dynamically establishing a filtering rule corresponding to this sensitive key “user001.passport_num”.

On the other hand, if step S200 determines a value is not sensitive, step S206 is executed for writing the data into the database 120. For example, step S200 may determine the value “Hello, everyone!” does not involve any sensitive contents, such that the key “user001.text” does not require a filtering rule.

At this time, the data processing unit 140 may execute step S204 to store the filtering rule about the corresponding key (e.g., “user001.email”) into the filtering rule database 160. After the filtering rule is generated automatically, the data processing unit 140 executes step S206 for writing the data, which the user terminal 180 tries to establish, into the database 120. To be added that, the data written into the database 120 is the origin data without a masking treatment.

In addition, the filtering rule database 160 can be a stand-alone database independent from the database 120, but the invention is not limited thereto. In another embodiment, the filtering rule database 160 can be integrated into the database 120. In this case, the data processing unit 140 may separate the written data and the filtering rules into different storage spaces within the database 120.

To be added that, step of writing the data into the database (S206) and steps of generating and storing the filtering rules (S202 and S204) are not limited to a specific sequential relationship. In practices, the step of writing the data into the database (S206) may exchange its sequential order with steps of generating and storing the filtering rules (S202 and S204), or these steps can be executed in parallel.

The dynamic masking method and the database system selectively generate the filtering rule according to the values/keys in the data to be written dynamically during the stage of data-writing, and store the original data into the database. In comparison with the traditional static masking technology, aforesaid embodiment is capable of remaining the completeness of the original data written in the database. In comparison with the traditional dynamic masking technology, aforesaid embodiment is capable of analyzing the contents of the data and generating the filtering rule automatically during the stage of data-writing.

As shown in FIG. 1 and FIG. 3, it is assumed that the user terminal 180 requests to read one data (including at least one key assigned in this reading procedure) or multiple data related to one specific key in the database 120. At this time, the data processing unit 140 executes step S300 for determining whether a key requested to be read is sensitive or not.

If the data processing unit 140 determines that the key requested to be read is sensitive in step S300, the data processing unit 140 executes step S302 for loading the filtering rule corresponding to the key requested to be read.

Afterward, step S304 is executed that the data processing unit 140 read the data contents (including the value of the data) requested by the user terminal 180 from the database 120 (the database 120 stores the original data contents completely), and the data processing unit 140 performs a masking treatment onto the value corresponding to the key requested to be read according to the filtering rule. For example, if the key requested by the user terminal 180 requests is “user001.email” (referring to the example in Table 1), the filtering rule can be loaded to replace the first character to the third character (of the value) with the character “*”.

Afterward, the data processing unit executes step S306 for replying the value corresponding to the requested key after the masking treatment (i.e., the masking treatment in Step 304) to the user terminal 180. In this embodiment, the value replied to the user terminal 180 is in the format after masking treatment, e.g., “**123gmail.com”, such as to protect the sensitive data.

On the other hand, if the requested key is determined to be not sensitive by step S300, the data processing unit may execute step S306 for replying the value corresponding to the requested key to the user terminal 180 directly without a masking treatment.

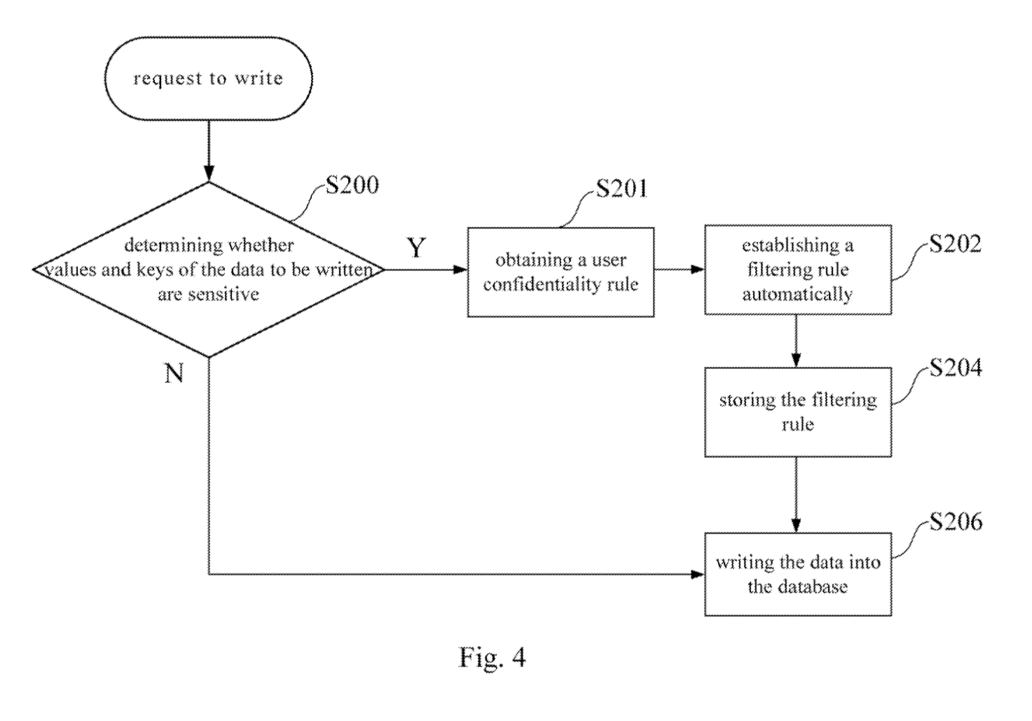

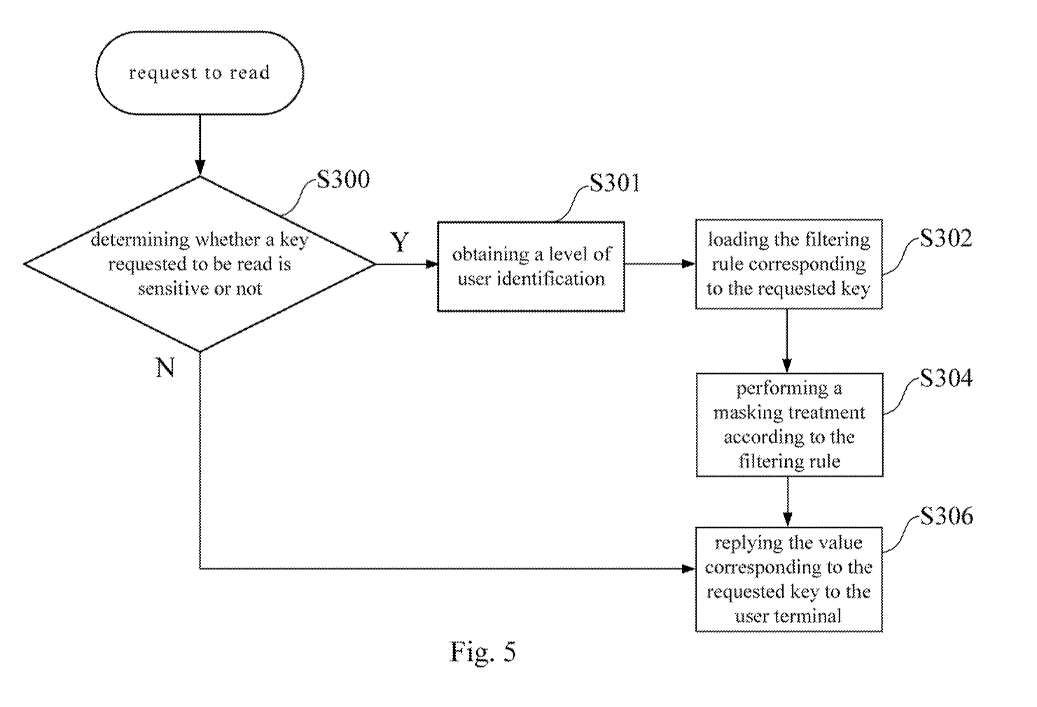

In addition, the dynamic data masking method and the database system 100 may further generate different results after the filtering of sensitive data according to different levels of user identifications. Reference is made to FIG. 4 and FIG. 5 as well. FIG. 4 is a flowchart illustrating the data masking method during the data-writing stage according to another embodiment of the invention. FIG. 5 is a flowchart illustrating the data masking method during the data-reading stage according to another embodiment of the invention.

In the embodiment shown in FIG. 4 and FIG. 5, the dynamic data masking method may generate different results after the filtering of sensitive data according to different levels of user identifications.

In the stage of data-writing, referring to FIG. 1, FIG. 2 and FIG. 4, the embodiment shown in FIG. 4 further includes step S201 for obtaining a user confidentiality rule, in comparison with the embodiment shown in FIG. 2. In the embodiment, the user confidentiality rule can be stored in the data processing unit 140. The user confidentiality rule includes different levels of user identifications, such as a visitor, an internal employee, a system administrator, etc.

In the embodiment shown in FIG. 4, when the data processing unit 140 executes step S202 for dynamically establishing a filtering rule corresponding to the sensitive key, the data processing unit 140 further establishes different filtering rules relative to one key for corresponding to the different levels of user identifications according to the user confidentiality rule.

There is an example of the filtering rules to the same key “user001.email”. The filtering rule at the visitor level can be replacing all characters of the values with the character “*”. The filtering rule at the internal employee level can be replacing the first to the third characters of the values with the character “*”. The filtering rule at the system administrator level can be no replacement on the strings of the values.

In other words, three individual filtering rules are established corresponding to the same key “user001.email” for different levels of user identification. These three individual filtering rules can be the same or different between each others.

On the other hand, in the stage of data-reading, referring to FIG. 1, FIG. 3 and FIG. 5, the embodiment shown in FIG. 5 further includes step S301 for obtaining a level of user identification on the user terminal 180 (i.e., current requesting terminal), in comparison with the embodiment shown in FIG. 3.

Afterward, during step S302 of loading the filtering rule corresponding to the key requested to be read, the data-processing unit 140 loads the filtering rule according to the key requested to be read and the level of user identification of current requesting at the same time.

In other words, in respect to the reading request related to the key “user001.email”, the replying value viewed by the visitor level can be “*****************”; the replying value viewed by the internal employee level can be “***123gmail.com”; and, the replying value viewed by the system administrator level can be “abc123gmail.com”. Accordingly, the database system may provide a high flexibility for different users.

Based on aforesaid embodiments, the invention provides a dynamic data masking method and a database system. During the data-writing stage, the method is performed to scan values (and keys corresponding to the values) to be written into the database and dynamically establish the filtering rules according to the values (and the keys). During the data-reading stage, the method is performed to mask the response contents in real time with the filtering rules dynamically established before. The filtering rules in this invention are generated by automatic judgment during the data-writing stage according to whether the values (and the keys) are sensitive or not. The system supervisors are not required to define the sensitive keys or filtering rules by custom. Therefore, the dynamic data masking method is suitable for both of the new-typed non-relational database and traditional the relational database. In addition, an embodiment of the invention may further provide different inquiring result of sensitive data according to different levels of user identifications.

As is understood by a person skilled in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. A dynamic data masking method, suitable for a database for storing plural data, each data comprising plural values and plural keys corresponding to the values, the dynamic data masking method comprising:
determining whether values and keys of one data are sensitive or not when the data requests to be written into the database;
if one of the values or one of the keys in the data to be written is sensitive, setting a key corresponding to the sensitive value or the key itself as a sensitive key and dynamically establishing a filtering rule corresponding to the sensitive key; and
storing the filtering rule and writing the data into the database.

2. The dynamic data masking method as claimed in claim 1, wherein, during a procedure of writing data into the database, the dynamic data masking method further comprises:
obtaining a user confidentiality rule comprising a plurality of different levels of user identifications, wherein, during the step of dynamically establishing a filtering rule corresponding to the sensitive key, the dynamic data masking method further establishes a plurality of different filtering rules relative to one key for corresponding to the different levels of user identifications according to the user confidentiality rule.

3. The dynamic data masking method as claimed in claim 1, further comprising:
when there is a request to read the database, determining whether a key requested to be read is sensitive or not;
if the key requested to be read is sensitive, loading the filtering rule corresponding to the key requested to be read;
performing a masking treatment onto the value corresponding to the key requested to be read according to the filtering rule; and
replying with the value after the masking treatment.

4. The dynamic data masking method as claimed in claim 3, wherein, during a procedure of reading data from the database, the dynamic data masking method further comprises:
obtaining a level of user identification of current requesting, wherein, during the step of loading the filtering rule corresponding to the key requested to be read, the filtering rule is loaded according to the key requested to be read and the level of user identification of current requesting at the same time.

5. The dynamic data masking method as claimed in claim 1, wherein the dynamic data masking method determines whether the values and the keys are sensitive or not according to an algorithm or a lookup table, the algorithm is selected from at least one algorithm consisting of Regular Expression (regex) algorithm, Machine Learning algorithm and Signature algorithm.

6. A database system, comprising:
a database for storing a plurality of data, each data comprising plural values and plural keys corresponding to the values; and
a data processing unit communicatively connected with the database for processing a request to write in or read from the database,
wherein, when one data requests to be written into the database, the data processing unit determining whether values and keys of the data to be written are sensitive or not, if one of the values or one of the keys in the data to be written is sensitive, the data processing unit sets a key corresponding to the sensitive value or the key itself as a sensitive key and dynamically establishing a filtering rule corresponding to the sensitive key.

7. The database system as claimed in claim 6, wherein, when there is a request to read the database, the data processing unit determines whether a key requested to be read is sensitive or not, if the key requested to be read is sensitive, the data processing unit loads the filtering rule corresponding to the key requested to be read, the data processing unit performs a masking treatment onto the value corresponding to the key requested to be read according to the filtering rule, and the data processing unit replies with the value after the masking treatment.

8. The database system as claimed in claim 6, wherein the data processing unit is a network gateway, a controlling circuit integrated on a network gateway or a controlling circuit integrated on the database.

9. The database system as claimed in claim 6, wherein the data processing unit is a non-relational database or a relational database.

10. The database system as claimed in claim 6, wherein the data processing unit stores a user confidentiality rule comprising a plurality of different levels of user identifications, during the data processing unit dynamically establishing a filtering rule corresponding to the sensitive key, the data processing unit further establishes a plurality of different filtering rules relative to one key for corresponding to the different levels of user identifications according to the user confidentiality rule, and during the data processing unit reading data from the database, the data processing unit determines a level of user identification of current requesting, and the data processing unit loads the filtering rule according to the key requested to be read and the level of user identification of current requesting at the same time
